(19) United States
(12) Patent Application Publication
(10) Pub. No.: US 2026/0034940 A1
(43) Pub. Date: Feb. 5, 2026

(54) VEHICLE PART FASTENER ALLOWING FOR STYLE AND TOOLING FLEXIBILITY

(71) Applicant: Toyota Motor Engineering & Manufacturing North America, Inc., Plano, TX (US)

(72) Inventors: Paxton S. Williams, Milan, MI (US); Scott L. Frederick, Brighton, MI (US); Ryan C. Harris, Saline, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/794,989

(22) Filed: Aug. 5, 2024

(51) Int. Cl. B60R 3/00; F16B 2/20

(52) U.S. Cl. CPC B60R 3/00; F16B 2/20

(57) ABSTRACT

A step pad assembly includes a step pad including a plurality of raised pads protruding from an outer side of the step pad and providing a traction surface to promote sure footing of a user stepping on the traction surface. The step pad assembly further includes at least one clip fastener including a head portion, a stem portion, and a flexible finger extending from the stem portion. The head portion is configured to be detachably coupled at the outer side of the step pad. When installed on a vehicle or support member (e.g., a bumper cover or frame), the stem portion is configured to extend longitudinally from an inner side of the head portion, through an aperture disposed in the step pad, to an inner side of the step pad. The flexible finger can snap into the support member to secure the step pad to the support member.

### BACKGROUND

### 1. Field

The various aspects and embodiments described herein relate generally to vehicles and, in particular, to vehicle part fasteners.

### 2. Description of the Related Art

Step pads for vehicle bumpers often have a tread pattern that serves two purposes: (1) style and appearance and (2) customer usability. The attachment method used for step pads often include a molded-in, hidden clip on the underside of the step pad. This design limits the flexibility for exterior appearance and complicates tooling used for manufacture, resulting in higher costs for the manufacturer and customer. In this respect, it would be desirable if an apparatus were provided that provided flexibility in design and manufacture.

### SUMMARY

In general, one aspect of the subject matter described in this disclosure may be embodied in a vehicle. The vehicle includes a bumper support, a step pad, and a clip fastener. The bumper support includes a first aperture. The step pad is supported by the bumper support. The step pad includes a plurality of raised pads protruding from an outer side of the step pad and providing a traction surface to promote sure footing of a user stepping on the traction surface. The clip fastener includes a head portion, a stem portion, and a flexible finger extending from the stem portion. The head portion is configured to be detachably coupled at the outer side of the step pad. The stem portion is configured to extend longitudinally from an inner side of the head portion, through a second aperture disposed in the step pad, to an inner side of the step pad. The flexible finger is configured to snap into the first aperture of the bumper support to secure the step pad to the bumper support.

Another aspect of the subject matter described in this disclosure may be embodied in a step pad assembly. The step pad assembly includes a step pad and a clip fastener. The step pad includes a plurality of raised pads protruding from an outer side of the step pad and providing a traction surface to promote sure footing of a user stepping on the traction surface. The clip fastener includes a head portion, a stem portion, and a flexible finger extending from the stem portion. The head portion is configured to be detachably coupled at the outer side of the step pad. The stem portion is configured to extend longitudinally from an inner side of the head portion, through an aperture disposed in the step pad, to an inner side of the step pad. The flexible finger is configured to snap into a support panel to secure the step pad to the support panel when the step pad is fixedly attached to the support panel.

Another aspect of the subject matter described in this disclosure may be embodied in a clip fastener. The clip fastener includes a head portion, a stem portion, and a flexible finger extending from the stem portion. The head portion is shaped and sized to provide a traction surface to promote sure footing of a user stepping on the traction surface. The stem portion is configured to extend longitudinally from an inner side of the head portion.

These and other embodiments may optionally include on or more of the following features.

In various aspects, the plurality of raised pads and the head portion are arranged in a tread pattern.

In various aspects, each raised pad of the plurality of raised pads is formed as a first shape and the head portion is formed as a second shape, and the first shape is the same as the second shape.

In various aspects, the head portion and the stem portion are two separate pieces configured to be removably coupled to one another. In various aspects, the head portion includes a first attachment feature, and the stem portion includes a second attachment feature, and the head portion is configured to slide laterally with respect to the stem portion to couple the first attachment feature with the second attachment feature. In various aspects, the first attachment feature includes a protuberance extending from the inner side of the head portion and the second attachment feature includes a slot configured to receive the protuberance.

In various aspects, the clip fastener further includes a tab protruding from the inner side of the head portion and configured to contact the step pad to transfer lateral loads applied to the head portion between the head portion and the step pad.

In various aspects, the stem portion includes an end wall, the slot is disposed in the end wall, and the end wall includes an extension located at an opening of the slot to define a narrowed portion of the slot. The protuberance can include a necked portion configured to be received into the slot.

In various aspects, the head portion is shaped as a frustum.

### BRIEF DESCRIPTION OF THE DRAWINGS

Other apparatuses, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a perspective view of a vehicle according to an aspect of the present disclosure;

FIG. 2A illustrates a step pad assembly installed on a rear bumper of the vehicle according to an aspect of the present disclosure;

FIG. 2B illustrates a view of the underside of the step pad assembly of FIG. 2A according to an aspect of the present disclosure;

FIG. 3 illustrates a section view of a single-piece clip fastener in an installed position according to an aspect of the present disclosure;

FIG. 4 illustrates a section view of a two-piece clip fastener in an installed position according to an aspect of the present disclosure;

FIG. 5 is a perspective view of a one-piece clip fastener according to an aspect of the present disclosure;

FIG. 6A is a perspective view of a two-piece clip fastener according to an aspect of the present disclosure;

FIG. 6B is an assembly view of the two-piece clip fastener of FIG. 6A according to an aspect of the present disclosure;

FIG. 6C is a perspective view of a stem portion (e.g., a bottom piece) of the two-piece clip fastener of FIG. 6A according to an aspect of the present disclosure;

FIG. 6D is a perspective view of a head portion (e.g., a top piece) of the two-piece clip fastener of FIG. 6A according to an aspect of the present disclosure; and

FIG. 7 is a schematic view of the two-piece clip fastener of FIG. 6A with stopping tabs in an installed position according to an aspect of the present disclosure.

### DETAILED DESCRIPTION

Disclosed herein are apparatus, systems, and methods for implementing a step pad assembly for a vehicle. The step pad assembly includes a step pad including a plurality of raised pads protruding from an outer side of the step pad and providing a traction surface to promote sure footing of a user stepping on the traction surface. The step pad assembly further includes at least one clip fastener including a head portion, a stem portion, and a flexible finger extending from the stem portion. The head portion is configured to be detachably coupled at the outer side of the step pad. When installed on a vehicle or other support member, the stem portion is configured to extend longitudinally from an inner side of the head portion, through an aperture disposed in the step pad, to an inner side of the step pad. The flexible finger is configured to snap into the support member to secure the step pad to the support member.

The apparatus, systems, and methods described herein provide a clip fastener that can be made in either a one or two-piece configuration. In either configuration, the head portion of the clip fastener can be made unique to the particular tread pattern of the step pad and/or the location that the clip is being used. In the two-piece design, a common stem portion design can be used with a variety of head portions of various shapes and sizes. For example, the head portion can be various shapes, sizes, and/or colors. Moreover, the head portion can define a portion of the tread pattern and provide, at least in part, the traction surface to promote sure footing of a user. The apparatus, systems, and methods described herein allow for ease of manufacturing of the step pad, for example which can be manufactured using a plastic molding process.

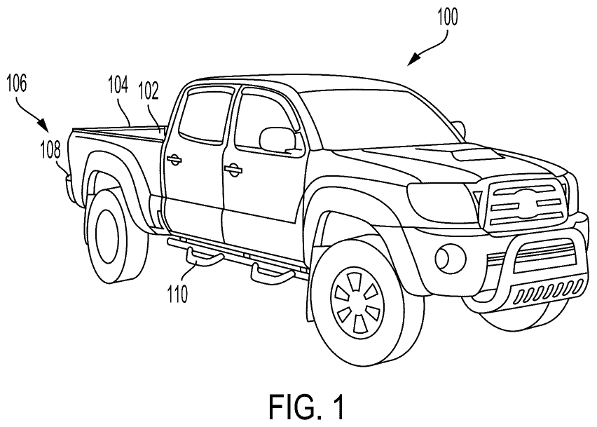

FIG. 1 illustrates a perspective view of a vehicle 100 having one or more step pads, in accordance with various aspects. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a pick-up truck, an SUV, a UTV, a minivan, a stain wagon, or another other motor or battery driven vehicle. For example, the vehicle 100 may be an electric vehicle, a hybrid vehicle, a plug-in hybrid vehicle, a fuel cell vehicle, or any other type of vehicle that includes a motor/generator. FIG. 1 depicts a pick-up truck by example. The vehicle 100 may be an autonomous or semi-autonomous vehicle having self-driving capabilities. The vehicle 100 may have a truck bed 102 enclosed by a tailgate 104 from a rear end 106. The vehicle 100 may have a rear bumper 108 having one or more step pads whereby a user may access the truck bed 102. The vehicle 100 may have a sidestep 110 (e.g., running board, etc.) having one or more step pads whereby a user may access the truck bed 102 or the cabin of the vehicle 100, or any other suitable location of the vehicle 100.

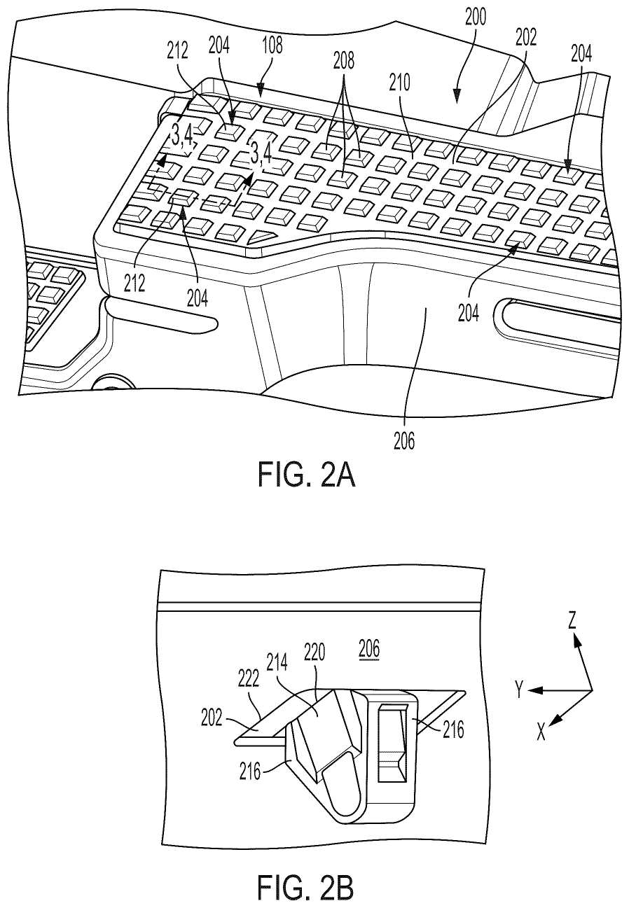

FIGS. 2A and 2B show views of a step pad assembly 200 coupled to the vehicle 100 in accordance with various aspects. The step pad assembly 200 can be installed to the rear bumper 108, in accordance with various aspects. The step pad assembly 200 can be installed to any suitable location of the vehicle 100 where a traction surface to promote sure footing of a user stepping on the traction surface is desired. The step pad assembly 200 generally includes a step pad 202 and one or more clip fasteners 204 for securing the step pad 202 to a support member 206 (e.g., a bumper support). The support member 206 can support the step pad 202. The support member 206 can be a panel, such as a panel for a bumper support.

The step pad 202 includes a plurality of raised pads 208 protruding from an outer side of the step pad 202. The plurality of raised pads 208 provide a traction surface to promote sure footing of a user stepping on the traction surface. In various aspects, the step pad 202 includes a base layer 210 and the plurality of raised pads 208 extend from the base layer 210. The base layer 210 can be a sheet of material (e.g., plastic material). The base layer 210 can be a generally planar layer of material, though the shape of the base layer 210 can vary depending on the shape of the support member 206 to which the step pad 202 is being installed. In various aspects, the base layer 210 and the plurality of raised pads 208 are formed as a single piece of material. For example, the base layer 210 and the plurality of raised pads 208 are formed as a single piece of material during an injection molding process, a compression molding process, and extrusion molding process, or the like. The step pad 202 may be manufactured from metal, plastic, a composite material, or any other suitable material.

Each clip fastener 204 can include a head portion 212, a stem portion 214, and one or more flexible fingers 216 (e.g., a first flexible finger 216 and a second flexible finger 216) extending from the stem portion 214. The clip fastener 204 can be detachably coupled to the step pad 202 with the head portion 212 disposed at the outer side of the step pad 202 and the stem portion 214 and flexible fingers 216 disposed at the inner side of the step pad 202. With particular focus on FIG. 2B, the stem portion 214 can extend longitudinally (i.e., along the Z-direction in FIG. 2B) from an inner side of the head portion 212 through a first aperture 220 disposed in the step pad 202 and through a second aperture 222 disposed in the support member 206. In this regard, in the installed position, the head portion 212 can be located at the outer side of the step pad 202 and the stem portion 214 can be located at the inner side of the step pad 202. When installing the clip fastener 204, as the stem portion 214 is moved through the aperture 222 the fingers 216 can flex inward toward the stem portion 214 to fit through the aperture 222 and then snap into the aperture 222 of the support member 206 to secure the step pad 202 to the support member 206.

In various aspects, the plurality of raised pads 208 and the head portions 212 are arranged in a tread pattern. For example, FIG. 2A shows the plurality of raised pads 208 and the head portions 212 arranged in a plurality of rows and columns. A tread pattern can be any desired pattern of a traction surface to promote sure footing of a user stepping on the traction surface. In various aspects, the shape and/or size of the head portion 212 are the same or similar to the shape and/or size of the raised pads 208. The head portions 212 are illustrated in FIG. 2A as having a rectangular shape (e.g., a square shape); however, the shape of the head portions 212 and/or raised pads 208 can be any suitable shape (e.g., rectangular, round, polygonal, etc.). The head portions 212 can be shaped as a frustum (i.e., the base portion of a cone or pyramid obtained by cutting the apex portion with a plane parallel to the base; also referred to as a flat-top pyramid or cone).

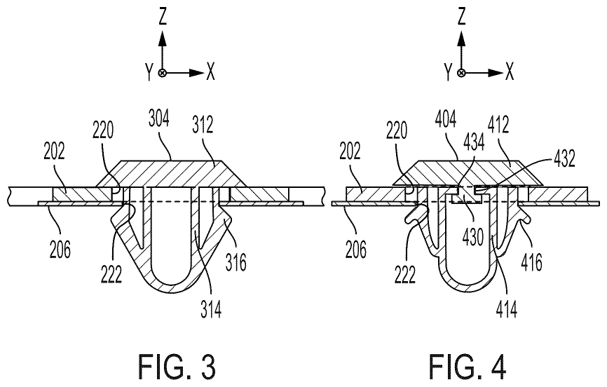

FIG. 3 is a section view of a one-piece clip fastener 304 in an installed position, in accordance with various aspects. With respect to FIG. 3, elements with like element numbering, as depicted in FIG. 2, are intended to be the same and will not necessarily be repeated for the sake of clarity. In various aspects, the clip fastener 304 can be similar to the clip fastener 204 as described with respect to FIG. 2A and FIG. 2B. The clip fastener 304 can include the head portion 312, the stem portion 314, and the flexible fingers 316, all formed as a single piece of material. An inner surface of the head portion 312 of the clip fastener 304 can rest against the step pad 202. The stem portion 314 can extend through the aperture 220 disposed in the step pad 202. The stem portion 314 can extend through the aperture 222 disposed in the support member 206. The flexible fingers 316 can extend from the stem portion 314 and contact the support member 206 at the aperture 222 to secure the clip fastener 304 in the installed position and to secure the step pad 202 with respect to the support member 206.

FIG. 4 is a section view of a two-piece clip fastener 404 in an installed position, in accordance with various aspects. With respect to FIG. 4, elements with like element numbering, as depicted in FIG. 2, are intended to be the same and will not necessarily be repeated for the sake of clarity. In various aspects, the clip fastener 404 can be similar to the clip fastener 204 as described with respect to FIG. 2A and FIG. 2B. The clip fastener 404 can include the head portion 412, the stem portion 414, and the flexible fingers 416. An inner surface of the head portion 412 of the clip fastener 404 can rest against the step pad 202. The stem portion 414 can extend through the aperture 220 disposed in the step pad 202. The stem portion 414 can extend through the aperture 222 disposed in the support member 206. The flexible fingers 416 can extend from the stem portion 414 and contact the support member 206 at the aperture 222 to secure the clip fastener 404 in the installed position and to secure the step pad 202 with respect to the support member 206.

In various aspects, the head portion 412 is formed as a separate piece from the stem portion 414 and the flexible fingers 416. Stated differently, the head portion 412 and the stem portion 414 can be two separate pieces configured to be removably coupled to one another. For example, the head portion 412 can include a first attachment feature 430 and the stem portion 414 can include a second attachment feature 432 whereby the head portion 412 is attached to the stem portion 414. The head portion 412 can be configured to slide laterally (e.g., along the Y-axis in FIG. 4) with respect to the stem portion 414 to couple the first attachment feature 430 with the second attachment feature 432. In various aspects, the first attachment feature 430 includes a protuberance (e.g., a tab, a flange, a knob, and/or any other suitable protuberance) extending from the inner side of the head portion 412. The second attachment feature 432 includes a slot 434 configured to receive the protuberance. The second attachment feature 432 can be located at the uppermost end of the stem portion 414. The second attachment feature 432 can be configured to contact the inner surface of the head portion 412.

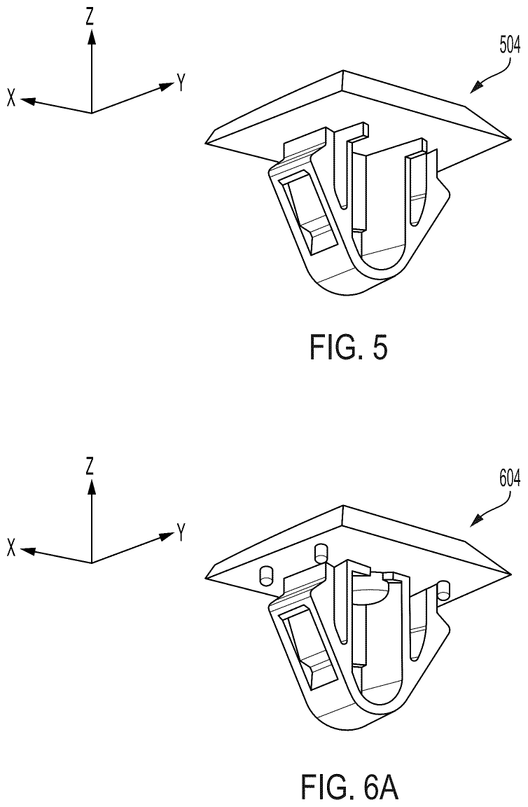

FIG. 5 is a perspective view of a one-piece clip fastener 504, in accordance with various aspects. The one-piece clip fastener 504 can be similar to the one-piece clip fastener 304 of FIG. 3, in accordance with various aspects.

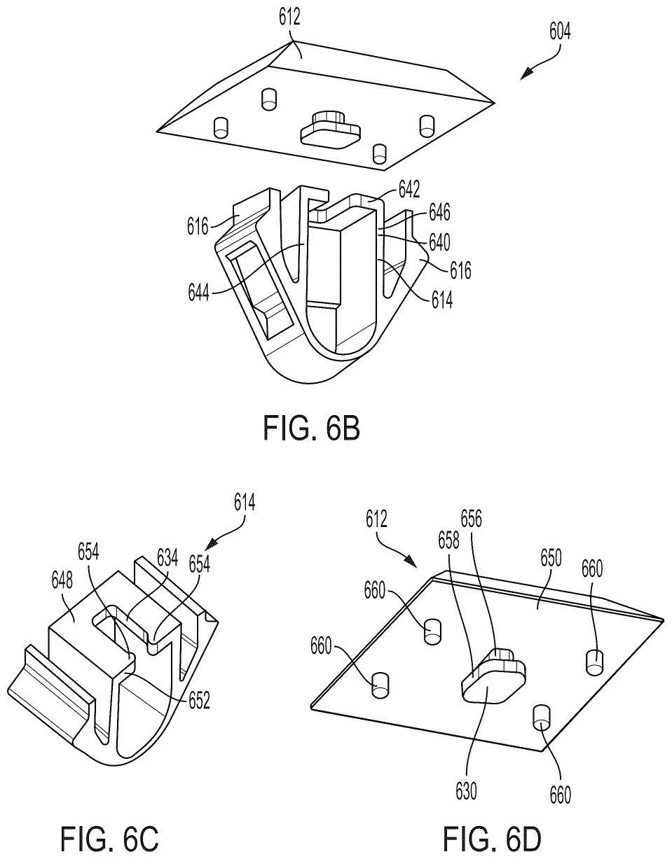

FIG. 6A is a perspective view of a two-piece clip fastener 604, in accordance with various aspects. The two-piece clip fastener 604 can be similar to the two-piece clip fastener 404 of FIG. 4, in accordance with various aspects.

FIG. 6B is an assembly view of the clip fastener 604. In various aspects, the stem portion 614 includes a generally U-shaped body 640 with an end wall 642 extending between and to a first wall 644 of the body 640 and a second wall 646 of the body 640. The end wall 642 can be a generally planar wall. The end wall 642 can define a planar distal surface 648 (see FIG. 6C) of the stem portion 614 that is configured to contact the inner surface 650 (see FIG. 6D) of the head portion 612. The inner surface 650 can be a planar surface.

FIG. 6C is a perspective view of the stem portion 614 of the clip fastener 604. The end wall 642 can define the slot 634. The slot 634 can extend from a front face 652 of the stem portion 614. The sot 634 can include clip locking features that include extensions 654 that extend into the slot 634 to define a narrowed portion at the opening of the slot 634. A necked portion 656 (i.e., a narrowed portion) of the first attachment feature 630 can be slightly wider than the narrowed portion of the slot 634 so that when the necked portion 656 is inserted into the slot 634, the extensions 654 flex outward from one another to permit the necked portion 656 to move into the slot 634 and then flex (e.g., also referred to as snap) back toward one another to capture and secure the necked portion 656 from exiting the slot 634. The first attachment feature 630 can further include a flange 658 extending from the necked portion 656. A width of the flange 658 is wider than the necked portion 656 and wider than the slot 634 to stop the first attachment feature 630 from existing the slot 634 in the longitudinal direction.

FIG. 6D is a perspective view of the head portion 612 of the clip fastener 604. In various aspects, one or more ribs or tabs 660 protrude from the inner side of the head portion 612. The tabs 660 can be arranged distally from the first attachment feature 630. The tabs 660 can extend longitudinally from the inner side of the head portion 612. For example, the tabs 660 and the stem portion 614 can extend in the same direction (e.g., in parallel). In various aspects, the head portion includes four tabs 660, though the head portion 612 can include two tabs 660 or a single tab 660 in various aspects.

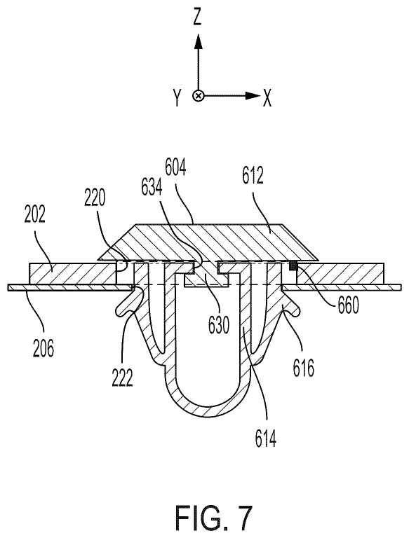

FIG. 7 is a schematic view of the clip fastener 604 in an installed position, in accordance with various aspects. The one or more tabs 660 can be configured to contact the step pad 202 to transfer lateral loads applied to the head portion 612 between the head portion 612 and the step pad 202. The one or more tabs 660 can be configured to contact the step pad 202 at the aperture 220. For example, the tab 660 can act as a stopping surface to prevent the head portion 612 from sliding laterally (i.e., along the Y-direction in FIG. 7) which could undesirably cause the head portion 612 from detaching from the stem portion 614 as a result of the first attachment feature 630 exiting the slot 634.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Furthermore, no element, component, or method step in the present disclosure is intended to be dedicated to the public regardless of whether the element, component, or method step is explicitly recited in the claims. No claim element herein is intended to invoke 35 U.S.C. 112(f) unless the element is expressly recited using the phrase “means for.”

What is claimed is:

1. A vehicle comprising:
a bumper support including a first aperture;
a step pad supported by the bumper support, the step pad including a plurality of raised pads protruding from an outer side of the step pad and providing a traction surface to promote sure footing of a user stepping on the traction surface; and
a clip fastener including a head portion, a stem portion, and a flexible finger extending from the stem portion, the head portion is configured to be detachably coupled at the outer side of the step pad, the stem portion is configured to extend longitudinally from an inner side of the head portion, through a second aperture disposed in the step pad, to an inner side of the step pad, and the flexible finger is configured to snap into the first aperture of the bumper support to secure the step pad to the bumper support.

2. The vehicle of claim 1, wherein the plurality of raised pads and the head portion are arranged in a tread pattern.

3. The vehicle of claim 2, wherein each raised pad of the plurality of raised pads is formed as a first shape and the head portion is formed as a second shape, and the first shape is the same as the second shape.

4. The vehicle of claim 1, wherein the head portion and the stem portion are two separate pieces configured to be removably coupled to one another.

5. The vehicle of claim 4, wherein the head portion includes a first attachment feature, the stem portion includes a second attachment feature, and the head portion is configured to slide laterally with respect to the stem portion to couple the first attachment feature with the second attachment feature.

6. The vehicle of claim 4, wherein the clip fastener further comprises a tab protruding from the inner side of the head portion and configured to contact the step pad to transfer lateral loads applied to the head portion between the head portion and the step pad.

7. A step pad assembly, comprising:
a step pad including a plurality of raised pads protruding from an outer side of the step pad and providing a traction surface to promote sure footing of a user stepping on the traction surface; and
a clip fastener including a head portion, a stem portion, and a flexible finger extending from the stem portion, the head portion is configured to be detachably coupled at the outer side of the step pad, the stem portion is configured to extend longitudinally from an inner side of the head portion, through an aperture disposed in the step pad, to an inner side of the step pad, and the flexible finger is configured to snap into a support panel to secure the step pad to the support panel when the step pad is fixedly attached to the support panel.

8. The step pad assembly of claim 7, wherein the plurality of raised pads define a tread pattern, and the head portion defines a portion of the tread pattern.

9. The step pad assembly of claim 7, wherein the head portion and the stem portion are two separate pieces configured to be removably coupled to one another.

10. The step pad assembly of claim 7, wherein the head portion includes a first attachment feature, the stem portion includes a second attachment feature, and the head portion is configured to slide laterally with respect to the stem portion to couple the first attachment feature with the second attachment feature.

11. The step pad assembly of claim 10, further comprising a tab protruding from the inner side of the head portion and configured to contact the step pad to transfer lateral loads applied to the head portion between the head portion and the step pad.

12. The step pad assembly of claim 10, wherein the first attachment feature includes a protuberance extending from the inner side of the head portion and the second attachment feature includes a slot configured to receive the protuberance.

13. The step pad assembly of claim 7, wherein each raised pad of the plurality of raised pads is a first shape and the head portion is a second shape, and the first shape is the same as the second shape.

14. A clip fastener, comprising:
a head portion configured to provide a traction surface to promote sure footing of a user stepping on the traction surface;
a stem portion configured to extend longitudinally from an inner side of the head portion; and
a flexible finger extending from the stem portion.

15. The clip fastener of claim 14, wherein the head portion and the stem portion are two separate pieces configured to be removably coupled to one another.

16. The clip fastener of claim 15, wherein the head portion includes a first attachment feature, the stem portion includes a second attachment feature, and the head portion is configured to slide laterally with respect to the stem portion to couple the first attachment feature with the second attachment feature.

17. The clip fastener of claim 16, wherein the first attachment feature includes a protuberance extending from the inner side of the head portion and the second attachment feature includes a slot configured to receive the protuberance.

18. The clip fastener of claim 17, wherein:
the stem portion includes an end wall, the slot is disposed in the end wall, and the end wall includes an extension located at an opening of the slot to define a narrowed portion of the slot; and
the protuberance includes a necked portion configured to be received into the slot.

19. The clip fastener of claim 14, further comprising a tab extending longitudinally from the inner side of the head portion.

20. The clip fastener of claim 14, wherein the head portion is shaped as a frustum.
